(19) United States
(12) Patent Application Publication
(10) Pub. No.: US 2008/0247772 A1
(43) Pub. Date: Oct. 9, 2008

(54) XEROGRAPHIC COPYING APPARATUS AND METHOD OF CONTROLLING MOTOR

(75) Inventors: Kazufumi Ishida, Sunto-gun (JP); Masato Ogasawara, Katsushika-ku (JP); Hiroshi Katakura, Izunokuni-shi (JP); Hideaki Fukaya, Mishima-shi (JP); Kazuo Matsumoto, Numazu-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/696,504

(22) Filed: Apr. 4, 2007

(51) Int. Cl. G03G 15/14

(52) U.S. Cl. 399/66

(57) ABSTRACT

In a xerographic copying apparatus of the invention, a control unit to control a stepping motor to cause rotation of an image supporting body to synchronize with running of a transfer medium performs acceleration and deceleration of a rotation speed of the image supporting body while the image supporting body is rotating in a reverse rotation direction, and accordingly, paper powder or foreign matter accumulated in a cleaning mechanism to clean a developer on the image supporting body can be collected, the occurrence of abnormal noise is prevented, and a definite amount of reverse rotation of the image supporting body can be realized while avoiding damage of the image supporting body due to a speed difference between the image supporting body and the transfer medium.

### BACKGROUND OF THE INVENTION

1. Field of the Invention

The present invention relates to a xerographic copying apparatus suitable for use in, for example, a xerographic image forming apparatus and a method of controlling a motor used in the xerographic copying apparatus.

2. Description of the Related Art

In a xerographic image forming apparatus, a toner image formed on an image supporting body is finally moved to a recording medium through a transfer process. As a technique to collect a toner on the surface of an image supporting body, there is proposed a xerographic copying apparatus in which a current supplied to a drive motor is made smaller when the image supporting body is reversely rotated than when it is normally rotated (for example, JP-A-8-123284). Besides, there is proposed a cleaning apparatus in which a collection belt is provided between an upstream first blade and a downstream second blade, and is disposed to be in non-contact with an image supporting body and to be rotatable in the opposite direction to the movement direction of the image supporting body (for example, JP-A-2005-242025).

Paper powder or foreign matter accumulated at the edge of an elastic member is moved to a collection unit by the operation of reverse rotation of the image supporting body. In order to drive the image supporting body in the reverse rotation direction, the drive motor is often operated so that the shaft of the drive motor operating in the normal rotation is reversely rotated. From design for space saving necessary for miniaturization of a machine body or request for power saving in view of environment, a small drive motor is often used. A stepping motor has features that a shaft can be stopped at an arbitrary position or angle, and a case where a large torque is required can be dealt with. There is also a feature that the range of choice of kinds of the stepping motor is large. In order to finely perform the control, as the drive motor, the stepping motor is used more often than a DC (Direct Current) motor.

In the case where a small stepping motor is used, there is a case where the natural frequency of the stepping motor is shifted to a high frequency side, and at the time of operation of reverse rotation, the natural frequency of the stepping motor approaches the frequency of the minimum rotation pulse. In this case, since the resonance is produced, abnormal noise occurs. In order to prevent the occurrence of the abnormal noise, it is used to shift the resonance frequency of the stepping motor. For example, something like a vibration-proof rubber is bonded to the stepping motor. However, the bonding to the motor increases the cost, and there is a case where the effect is not perfect.

Besides, there is also a use in which the stepping motor is used in a range where the rotation pulse at the time of operation of reverse rotation or the pulse width of the rotation pulse is made large to prevent the resonance from occurring. When the pulse width of the rotation pulse is made large, the stepping motor can not follow the speed of the pulse, and loss of synchronism, that is, out of synchronization occurs. Further, there is an upper limit for the amount of reverse rotation of the shaft. At the edge part of the elastic member or the edge, not only the paper powder or foreign matter is accumulated, but also the collected toner exists. When the stepping motor performs the operation of reverse rotation, a trace (for example, band-like one) of the toner formed at the edge part of the elastic member occurs on the image supporting body. Only in the range where the toner trace does not influence the image, the stepping motor can perform the operation of the reverse rotation. That is, the trace of the toner determines the upper limit of the amount of the reverse rotation of the shaft.

On the contrary, there is also a use of the stepping motor in which the pulse width of the rotation pulse is made small to prevent the resonance from occurring. According to this use, after one pulse is inputted, the rotation angle of the shaft exceeds a desired angle by overshoot, and accordingly, the shaft is returned in the reverse direction, attenuation vibration occurs, and abnormal noise occurs.

### BRIEF SUMMARY OF THE INVENTION

It is an object of the present invention to provide a xerographic copying apparatus including a cleaning mechanism to clean a developer on an image supporting body.

In an aspect of the invention, a xerographic copying apparatus includes

a cleaning mechanism to clean a developer on a first image supporting body,

a transfer medium to which a developer on a second image supporting body is transferred and which can run in both directions,

at least one stepping motor to drive the first image supporting body and the transfer medium in a same direction and in different directions, and

control means for controlling the stepping motor to cause rotation of the first image supporting body to synchronize with running of the transfer medium and for performing at least one of acceleration and deceleration of rotation speed of the first image supporting body while the first image supporting body is rotating in a reverse rotation direction.

### DESCRIPTION OF THE DRAWINGS

FIG. 1 is a sectional arrow view of a xerographic copying apparatus according to an embodiment of the invention.

FIG. 2 is a view for explaining control means of the xerographic copying apparatus according to the embodiment of the invention.

FIG. 3 is a view showing a relation between a time and a rotation speed of a stepping motor when control of constant rotation in a reverse rotation direction is performed.

FIG. 4 is a view showing a relation between a time and a rotation speed of a stepping motor when control means of the embodiment of the invention performs acceleration and deceleration in the reverse rotation direction.

### DETAILED DESCRIPTION OF THE INVENTION

Throughout this description, the embodiments and examples shown should be considered as exemplars, rather than limitations on the apparatus and methods of the present invention.

Hereinafter, embodiments of the invention will be described in detail with reference to the accompanying drawings.

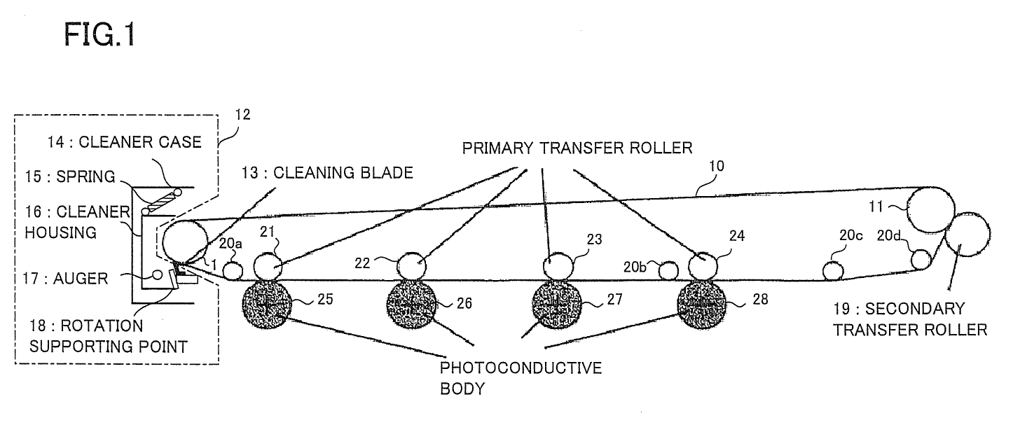

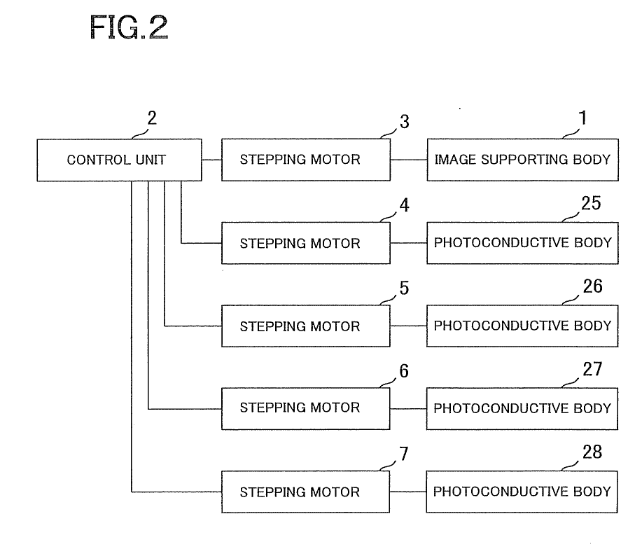

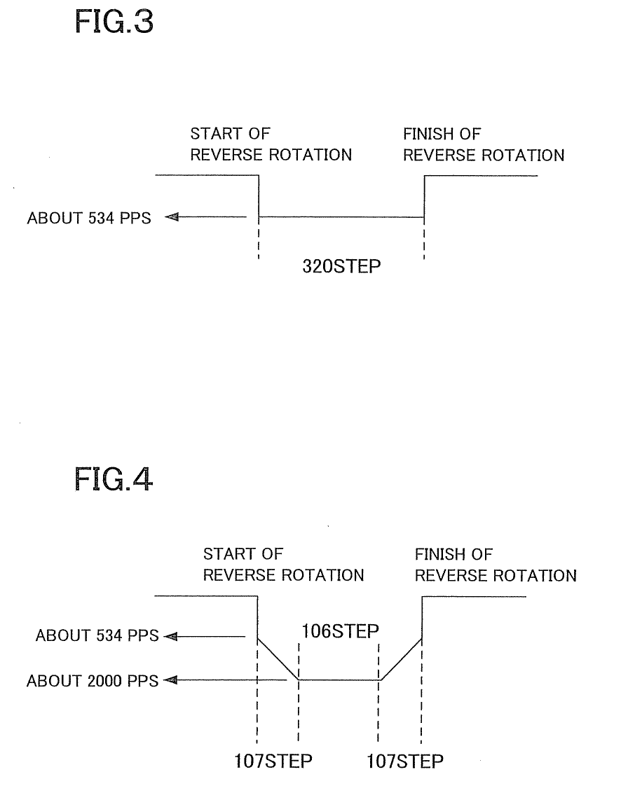

Incidentally, in the respective drawings, the same portions are denoted by the same symbols, and their duplicate explanation will be omitted. FIG. 1 is a sectional arrow view of a xerographic copying apparatus according to an embodiment of the invention, FIG. 2 is a view for explaining control means of the xerographic copying apparatus according to the embodiment of the invention, FIG. 3 is a view showing a relation between a time and a rotation speed of a stepping motor when control of constant rotation in a reverse rotation direction is performed, and FIG. 4 is a view showing a relation between a time and a rotation speed of a stepping motor when control means of the embodiment of the invention performs acceleration and deceleration in the reverse rotation direction. In FIGS. 3 and 4, the horizontal axis and the vertical axis indicate the time and the rotation speed of the stepping motor, respectively.

A xerographic copying apparatus according to the embodiment of the invention is applied to a xerographic image forming apparatus. In the image forming apparatus of the embodiment, toner images formed by photoconductive bodies to form plural images corresponding to plural different colors are superimposed on an endless intermediate transfer belt to form a multi-color toner image, the formed multi-color toner image is conveyed to a secondary transfer unit, and the multi-color toner image on the intermediate transfer belt is transferred to a sheet by the secondary transfer unit. A sectional arrow view of the image forming apparatus viewed in a direction parallel to a rotation shaft of a roller to convey the intermediate transfer belt is as shown in FIG. 1.

The image forming apparatus of the embodiment includes an image supporting body 1, an intermediate transfer belt 10, photoconductive bodies 25 to 28, primary transfer rollers 21 to 24, tension rollers 20a to 20d, a secondary transfer roller 19, a backup roller 11, and a cleaning mechanism 12.

The image supporting body 1 is a first image supporting body, and is driven by a stepping motor 3 as shown in FIG. 2. The stepping motor 3 is a first stepping motor, and drives the rotation of the image supporting body 1. In the following description, it is assumed that the normal rotation direction is a counterclockwise direction.

Each of the photoconductive bodies 25 to 28 is a second image supporting body. Stepping motors 4 to 7 drive the photoconductive bodies 25 to 28 in the normal rotation direction and in the reverse rotation direction. The stepping motors 4 to 7 are also a second stepping motor to drive the running of the intermediate transfer belt 10.

The image forming apparatus of the embodiment uses the separate stepping motors 3 to 7 as drive sources to perform the reverse rotation operation of the image supporting body 1 and the photoconductive bodies 25 to 28. The characteristics of the stepping motors 3 to 7 are represented by a rotation angle (denoted by STEP) of a shaft per one pulse.

A control unit 2 is control means for controlling the stepping motors 3 to 7 to cause the rotation of the image supporting body 1 to synchronize with the running of the intermediate transfer belt 10 and for performing acceleration and deceleration of the rotation speed of the image supporting body 1 while the image supporting body 1 is rotating in the reverse rotation direction. The image supporting body 1 and the photoconductive bodies 25 to 28 are driven by the stepping motors 3 to 7 to synchronize with each other in the normal rotation direction, the reverse rotation, and bidirectional rotation.

The control unit 2 controls the rotation speed of the image supporting body 1 and the running speed of the intermediate transfer belt 10. Specifically, the control unit 2 controls the respective amounts of rotation of the shaft of the stepping motor 3 and the shafts of the stepping motors 4 to 7 in the reverse rotation direction. The control unit 2 includes a CPU (Central Processing Unit), a ROM, a RAM and the like.

The intermediate transfer belt 10 of FIG. 1 is a transfer medium to which toner as the developer on the photoconductive bodies 25 to 28 is transferred and which can run in both directions. The image supporting body 1, the photoconductive bodies 25 to 28, and the intermediate transfer belt 10 constitute an intermediate transfer belt unit. When the image supporting body 1 is rotated in the normal rotation direction, the intermediate transfer belt 10 runs in the forward direction. In the following description, this movement is called a normal rotation operation of the intermediate transfer belt unit, and an operation reverse thereto is called a reverse rotation operation.

The primary transfer rollers 21 to 24 is for rotating and conveying the intermediate transfer belt 10, and respectively correspond to the photoconductive bodies 25 to 28. The photoconductive bodies 25 to 28 and the primary transfer rollers 21 to 24 are rotated, so that toner images of different colors are formed on the intermediate transfer belt 10.

The tension rollers 20a to 20d are for applying tensile forces to the intermediate transfer belt 10.

The secondary transfer roller 19 is for transferring the image transferred on the intermediate transfer belt 10 to a not-shown sheet. The transfer of the secondary transfer roller 19 to the intermediate transfer belt 10 is performed in cooperation with the backup roller 11.

The cleaning mechanism 12 is for cleaning the toner on the image supporting body 1, and includes a cleaning blade 13, an auger 17, a cleaner housing 16, a spring (elastic body) 15, and a cleaner case 14.

The cleaning blade 13 is a cleaning member to remove the toner on the image supporting body 1. The image supporting body 1 is rotated in a state where an edge part of the cleaning blade 13 is pressed to the surface of the image supporting body 1, so that the toner is scraped off. One end of the cleaning blade 13 is rotatably movably attached to the cleaner housing 16 so that the cleaning blade 13 can have two states of contact and non-contact with the image supporting body 1. A not-shown first drive motor drives the cleaning blade 13 so that the cleaning blade 13 becomes rotatably movable around a supporting point 18 of rotation as a first supporting point.

As a contact system of the cleaning blade 13 to the image supporting body 1, a counter system is used. The counter system is such that the edge part of the cleaning blade 13 brought into press contact with the image supporting body 1 is positioned before the rotation supporting point 18 of the cleaning blade 13 with respect to the normal rotation direction of the image supporting body 1. As the edge part of the cleaning blade 13, an elastic member such as, for example, an urethane rubber is used.

The auger 17 is developer conveying means for conveying the toner removed by the cleaning blade 13 to a not-shown toner containing unit.

The cleaning blade 13 and the auger 17 are contained in the cleaner housing 16. One end of the spring 15 is attached to the cleaner housing 16, and the other end of the spring 15 is attached to the cleaner case 14. The cleaner case 14 is a housing to support the cleaning blade 13 and the auger 17. The cleaning blade 13, the cleaner housing 16, and the spring 15 constitute a pressurization unit, and the pressurization unit presses both the cleaning blade 13 and the cleaner housing 16 to the image supporting body 1.

When the spring 15 attached to the cleaner case 14 mounted to a not-shown main body is contracted by this, the cleaner housing 16 is pulled up, and in synchronization with this, the cleaning blade 13 is rotated around the rotation supporting point 18, and the edge part of the cleaning blade 13 is pressed to the surface of the image supporting body 1.

In the method of controlling the motor according to the embodiment, the control unit 2 rotates the image supporting body 1 in the normal rotation direction at a specified speed. The control unit 2 once stops the image supporting body 1.

The control unit 2 accelerates the rotation of the image supporting body 1 so that the image supporting body 1 rotates in the reverse rotation direction at a constant first speed.

Then, the control unit 2 decelerates the rotation of the image supporting body 1 so that the image supporting body 1 rotates in the reverse rotation direction at a constant second speed having a value smaller than the first speed.

A method of controlling the motors of the photoconductive bodies 25 to 28 will be described, and the control of the rotation to the stepping motors 4 to 7 by the control unit 2 is performed as described below.

The control unit 2 rotates the shafts of the stepping motors 4 to 7 in the normal rotation direction at specified speed, so that the intermediate transfer belt 10 runs at the specified speed in the forward direction corresponding to the normal rotation direction.

The control unit 2 once stops the shafts of the stepping motors 4 to 7, so that the intermediate transfer belt 10 is stopped.

The control unit 2 accelerates the running of the intermediate transfer belt 10 so that the intermediate transfer belt 10 runs in the reverse direction corresponding to the reverse rotation direction at a speed corresponding to the first speed. That is, the control unit 2 accelerates the rotation of the shafts of the stepping motors 4 to 7 so that the shafts of the stepping motors 4 to 7 rotate in the reverse direction at the constant speed.

Then, the control unit 2 decelerates the running of the intermediate transfer belt 10 so that the intermediate transfer belt 10 runs in the reverse direction at a speed corresponding to a second speed. That is, the control unit 2 decelerates the rotation of the shafts of the stepping motors 4 to 7 so that the shafts of the stepping motors 4 to 7 rotate in the reverse rotation direction at the constant speed having a value smaller than the constant speed during the rotation.

As stated above, the control unit 2 drive-controls the stepping motor 3 so as to perform the acceleration and deceleration during the reverse rotation of the image supporting body 1.

When the intermediate transfer belt unit of the image forming apparatus of the embodiment performs the normal rotation operation by the foregoing structure, the toner, paper powder or the like is attached to the cleaning blade 13. The control unit 2 causes the intermediate transfer belt unit to operate in the reverse rotation in accordance with a specified condition. Hereinafter, a description will be given to a control operation at the time when the intermediate transfer belt unit of the image forming apparatus operates in the reverse rotation.

First, the operation at the time when the shaft of the stepping motor rotates at constant speed in the reverse rotation direction will be described.

In the case where the control unit 2 controls the shaft to rotate in the reverse rotation direction at the constant speed, as shown in FIG. 3, the natural frequency of the motor approaches the minimum rotation pulse of the stepping motor at the time of operation of the reverse rotation of the image supporting body 1, and therefore, the resonance is produced and abnormal noise occurs.

In this case, while the image supporting body 1 is rotating in the normal rotation direction at a specified constant speed, the execution instruction of the reverse rotation operation of the image supporting body 1 is issued to the control unit 2 from the main body, and the control unit 2 once stops the driving of the stepping motor. The state of the stop is held. After a specified time has passed, preparation by the control section 2 is performed so that the stepping motor drives the image supporting body 1 in the reverse rotation.

The value of the speed shown in FIG. 3 is a value at the time when the stepping motor is controlled by 1-2 phase control or half step control. The value of the speed is, for example, 534 PPS (Pulse Per Second) and is the value at the time when the stepping motor is driven in a self-activation region, and this value corresponds to the first step steed of the acceleration at the time of operation of the normal rotation. The stepping motor keeps this speed and is driven to rotate by 320 STEP (320 steps) in the reverse direction, and the control is finished.

Next, a description will be given to an operation at the time when the stepping motor 3 is controlled to be accelerated and decelerated while the shaft of the stepping motor 3 rotates in the reverse rotation direction.

As shown in FIG. 4, when the execution instruction of operation of the reverse rotation of the image supporting body 1 is issued from the main body to the control unit 2 while the image supporting body 1 is rotating in the normal rotation direction at a specified speed, the control unit 2 once stops the driving of the stepping motor 3. The state of the stop is held. After a specified time has passed, preparation by the control unit 2 is performed so that the stepping motor 3 drives the image supporting body 1 in the reverse rotation direction.

The value of the speed, in the reverse rotation direction, of the shaft of the stepping motor 3 is about 534 PPS (at the time of 1-2 phase control), and this value is one obtained at the time when the stepping motor 3 is driven in the self-activation region, and corresponds to the first step speed of the acceleration at the time of operation of the normal rotation. The stepping motor 3 is accelerated from about 534 PPS to about 2000 PPS, that is, for 107 STEP. The number of steps of 107 STEP corresponds to a time of 85.7 ms.

The speed of about 2000 PPS of the stepping motor 3 is held for 106 STEP, that is, for 53.5 ms in terms of time. Thereafter, the stepping motor 3 is decelerated for 107 STEP from about 2000 PPS to about 534 PPS, that is, for 85.7 ms in terms of time.

By this, the control of the reverse rotation direction by the control unit 2 is finished. Accordingly, the control unit 2 adjusts the rotation speed of the image supporting body 1 based on the natural frequency of rotation of the stepping motor 3 and the pulse width of the minimum rotation pulse of the stepping motor 3 when the image supporting body 1 rotates in the reverse rotation direction. By the control as stated above, the occurrence of abnormal noise is prevented.

Next, the control of FIG. 3 and the control of FIG. 4 will be compared with each other.

In the control shown in FIG. 3, at the time of the operation of the reverse rotation, the driving to the motor is continued in the state where the resonance is occurring due to the minimum rotation pulse of the stepping motor 3 and the normal frequency of the motor. Thus, noise sound occurs during the time of the reverse rotation of the image supporting body 1.

As compared with that, in the control shown in FIG. 4, while the image supporting body 1 is reversely rotating, the stepping motor 3 is accelerated and decelerated. In the case where this control is used, in the process in which the shaft is accelerated or decelerated, the region where the minimum rotation pulse of the stepping motor 3 and the normal frequency of the motor produce the resonance is instantaneously used. Since the time when the region is used is very short, noise sound is suppressed to such a level that no trouble occurs.

The image forming apparatus of the embodiment uses the stepping motors 3 to 7 having the feature that the shaft can be stopped at a desired position or angle. Thus, according to the invention, without using a feedback control in which a DC motor or the like is used and the shaft of the DC motor is stopped at a desired position, the stop position of the image supporting body 1 can be accurately controlled.

Further, in the image forming apparatus of the embodiment, since the control of the motor is performed using the inexpensive stepping motor 3, the manufacture cost can be reduced.

As stated above, in the image forming apparatus of the embodiment, a definite amount of reverse rotation of the shaft is realized while avoiding the damage of the image supporting body 1 due to the speed difference between the plural image supporting bodies generated when the intermediate transfer belt 10 and the photoconductive bodies 25 to 28 are driven. The amount of reverse rotation is, for example, 320 STEP. By this, the paper powder or foreign matter accumulated at the edge part of the cleaning blade 13 made of the elastic member is moved to the collection unit. The control by the control unit 2 is performed so that the amount of rotation of the shaft in the reverse direction falls within this range. The control unit 2 causes the stepping motor 3 to perform the reverse rotation operation, so that the trace (for example, band-like one) of toner formed by the edge part made of the elastic member on the image supporting body 1 does not influence the image. In other words, the control unit 2 adjusts the rotation speed of the image supporting body 1 in accordance with the influence exerted on the image by the toner on the image supporting body 1.

In the embodiment, although the contact system of the cleaning blade 13 to the image supporting body 1 is the counter system, the invention may use a trail system as the contact method. The trail system is such that the edge part of the cleaning blade 13 brought into press contact with the image supporting body 1 is positioned behind the rotation supporting point 18 of the cleaning blade 13 with respect to the normal rotation direction of the image supporting body 1. The control unit 2 performs the same speed control as the speed control shown in FIG. 3, so that the same effect as the above can be obtained.

In the invention, both the counter system and the trail system may be used. The image forming apparatus of the embodiment can be constructed such that the two cleaning blades 13 come in contact with the image supporting body 1. That is, the image forming apparatus of the embodiment may be provided with two or not less than three drive motors to drive the cleaning member of the image supporting body 1.

The image forming apparatus of the embodiment includes the cleaner housing 16 and the first drive motor to drive the cleaning blade 13, and further includes another cleaning blade (not shown) one end of which is attached to a position different from the rotation supporting point 18 in the cleaner housing 16 so as to have two states of contact and non-contact with the image supporting body 1, and a second drive motor (not shown) to drive the another cleaning blade so that the another cleaning blade becomes rotatably movable around a not-shown second rotation supporting point, and the control unit 2 can independently control the driving of the first drive motor and the driving of the second drive motor.

In this case, the control unit 2 controls the rotation amount of the shaft of the first drive motor and the rotation amount of the shaft of the second drive motor.

Besides, the control unit 2 may independently control the driving of the first drive motor and the driving of the second drive motor while each of the shaft of the stepping motor 3 and the shafts of the stepping motors 4 to 7 is being accelerated.

By this, the control unit 2 performs the same speed control as the speed control shown in FIG. 3. When both the counter system and the trail system are used, the toner collected by the elastic member brought into contact with the image supporting body 1 is conveyed to the toner containing part.

As stated above, according to the invention, both the counter system and the trail system can be used, the occurrence of abnormal noise is prevented, the damage of the image supporting body 1 is avoided, and a definite amount of reverse rotation of the shaft can be realized.

As stated above, according to the invention, the toner can be completely collected from the image supporting body 1, and it is prevented that a noise image is outputted on the recording medium to which the toner image is transferred.

Besides, in the case where a defect occurs during the conveyance of the recording medium or in the case where abnormality occurs in the transfer or the pattern formed on the image supporting body 1 in order to maintain the picture quality, there is a case where in an area of the image supporting body 1, non-transferred toner of an amount much larger than residual toner due to transfer must be collected. Also in such a case, according to the invention, the cleaning mechanism 12 can remove the toner effectively. Besides, since parts constituting the image forming apparatus are repeatedly used, it is needless to say that the invention can be used in a xerographic system.

In the embodiment, although the image supporting body 1 and the intermediate transfer belt 10 are driven by the different stepping motors, the image forming apparatus of the embodiment may use one stepping motor to drive the image supporting body 1 and the intermediate transfer belt 10 in the same direction and in the different directions. Even when the one stepping motor is used as the drive source and power generated by the one stepping motor is divided into plural powers, the same effect as the above can be obtained.

As the value of the speed in the embodiment, various values can be used so that the transfer to the intermediate transfer belt 10 is smoothly performed.

Although exemplary embodiments of the present invention have been shown and described, it will be apparent to those having ordinary skill in the art that a number of changes, modifications, or alternations to the invention as described herein may be made, none of which depart from the spirit of the present invention. All such changes, modifications, and alterations should therefore be seen as within the scope of the present invention.

What is claimed is:

1. A xerographic copying apparatus comprising:
a cleaning mechanism to clean a developer on a first image supporting body;
a transfer medium to which a developer on a second image supporting body is transferred and which can run in both directions;
at least one stepping motor to drive the first image supporting body and the transfer medium in a same direction and in different directions; and
control means for controlling the stepping motor to cause rotation of the first image supporting body to synchronize with running of the transfer medium and for performing at least one of acceleration and deceleration of a rotation speed of the first image supporting body while the first image supporting body is rotating in a reverse rotation direction.

2. The xerographic copying apparatus of claim 1, wherein
the control means controls the rotation speed of the first image supporting body and a running speed of the transfer medium.

3. The xerographic copying apparatus of claim 2, wherein the control means adjusts the rotation speed of the first image supporting body in accordance with an influence exerted on an image by the developer on the first image supporting body.

4. The xerographic copying apparatus of claim 2, wherein the control means adjusts the rotation speed of the first image supporting body based on a normal frequency of rotation of the stepping motor and a pulse width of a minimum rotation pulse of the stepping motor when the first image supporting body is rotating in the reverse rotation direction.

5. The xerographic copying apparatus of claim 1, wherein
there are provided:
a first stepping motor to drive the rotation of the first image supporting body; and
a second stepping motor to drive the running of the transfer medium, and wherein
the control means causes driving of the first stepping motor to synchronize with driving of the second stepping motor.

6. The xerographic copying apparatus of claim 5, wherein the control means controls an amount of rotation of a shaft of the first stepping motor and an amount of rotation of a shaft of the second stepping motor.

7. The xerographic copying apparatus of claim 1, wherein
there is provided:
a cleaning member to remove the developer on the first image supporting body;
developer conveying means for conveying the developer removed by the cleaning member to a specified place;
a housing to which one end of the cleaning member is rotatably movably attached to enable the cleaning member to have two states of contact and non-contact with the first image supporting body;
a first drive motor to drive the cleaning member to cause the cleaning member to become rotatably movable around a first supporting point;
another cleaning member one end of which is rotatably movably attached to a position different from the first supporting point in the housing to be capable of having two states of contact and non-contact with the first image supporting body; and
a second drive motor to drive the another cleaning member to cause the another cleaning member to become rotatably movable around a second supporting point, and wherein
the control means independently controls driving of the first drive motor and driving of the second drive motor.

8. The xerographic copying apparatus of claim 7, wherein the control means controls an amount of rotation of a shaft of the first drive motor and an amount of rotation of a shaft of the second drive motor.

9. A method of controlling at least one motor in a xerographic copying apparatus including a cleaning mechanism to clean a developer on a first image supporting body, a transfer medium to which a developer on a second image supporting body is transferred and which can run in both directions, at least one stepping motor to drive the first image supporting body and the transfer medium in a same direction and in different directions, and control means for controlling the stepping motor to cause rotation of the first image supporting body to synchronize with running of the transfer medium and for performing at least one of acceleration and deceleration of a rotation speed of the first image supporting body while the first image supporting body is rotating in a reverse rotation direction, the method comprising the steps of:
rotating, by the control means, the first image supporting body in a normal rotation direction at a specified speed;
stopping, by the control means, the first image supporting body;
accelerating, by the control means, the rotation of the first image supporting body to cause the first image supporting body to rotate in the reverse rotation direction at a first speed; and
decelerating, by the control means, the rotation of the first image supporting body to cause the first image supporting body to rotate in the reverse rotation direction at a second speed.

10. The method of controlling the motor of claim 9, further comprising the steps of:
running, by the control means, the transfer medium in a first direction corresponding to the normal rotation direction at a specified speed;
stopping, by the control means, the transfer medium;
accelerating, by the control means, the running of the transfer medium to cause the transfer medium to run in a second direction corresponding to the reverse rotation direction at a speed corresponding to the first speed; and
decelerating, by the control means, the running of the transfer medium to cause the transfer medium to run in the second direction at a speed corresponding to the second speed.
